(19) United States
(12) Patent Application Publication
(10) Pub. No.: US 2013/0159199 A1
(43) Pub. Date: Jun. 20, 2013

(54) CORRELATION-BASED DYNAMIC DETERMINATION OF TRANSACTIONAL INSTANCE CONTEXTS

(71) Applicants: Ulrich Keil, Heidelberg (DE); Marianne Brosche, Heidelberg (DE); Joachim Fessler, Grafenberg (DE); Holger Knospe, Wiesloch (DE); Jochen Mayerle, Flein (DE); Jochen Steinbach, Bad Schoenborn (DE); Otfried Geisau, Sinsheim-Eschelbach (DE)

(72) Inventors: Ulrich Keil, Heidelberg (DE); Marianne Brosche, Heidelberg (DE); Joachim Fessler, Grafenberg (DE); Holger Knospe, Wiesloch (DE); Jochen Mayerle, Flein (DE); Jochen Steinbach, Bad Schoenborn (DE); Otfried Geisau, Sinsheim-Eschelbach (DE)

(21) Appl. No.: 13/326,266

(22) Filed: Dec. 14, 2011

(51) Int. Cl. G06Q 10/00

(52) U.S. Cl. 705/304

(57) ABSTRACT

A current transactional context of a user of a business software architecture can be detected, optionally in response to a guidance request received from the user. At least one matching business process feature related to the current transactional context can be determined by comparing the current transactional context with process metadata in a process repository, and the matching business process feature can be compared to scenario metadata defining a set of business process features that are part of each of a plurality of business scenarios within the business configuration to identify at least one matching business scenario containing the matching business process feature. In a user interface, the at least one matching business process feature and the identified matching business scenario that contains the at least one matching business process feature can be highlighted.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-774F01US/2011P00201US, 34874-760F01US/2011P00149US, 34874-761F01US/2011P00163US, 34874-763F01US/2011P00166US, 34874-764F01US/2011P00167US, 34874-765F01US/2011P00168US, 34874-766F01US/2011P00169US, 34874-768F01US/2011P00171US, 34874-769F01US/2011P00172US, 34874-770F01US/2011P00173US, 34874-771F01US/2011P00174US, 34874-772F01US/2011P00175US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution.

### BACKGROUND

The complexity of business software architectures, such as for example enterprise resource planning (ERP) systems, can present substantial challenges to users and can be a serious obstacle to widespread operative use of business process models and business scenario models in the software landscape. Currently available business software architectures generally lack user interface capabilities to enable obtaining an overview of or navigating through the features and functionality along a concrete end-to-end business scenario with which a user is currently working or otherwise engaged. Business process and business scenario navigation features, such as for example those described in the related applications, can offer visualization of an end-to-end scenario in an intuitive and efficient manner that can provide valuable guidance and orientation to the user, both in the course of his or her day-to-day tasks and in situations where the user is learning a new business process or business scenario with which he or she is less familiar or proficient.

### SUMMARY

In one aspect, a method includes detecting a current transactional context of a user of a business software architecture and determining at least one matching business process feature related to the current transactional context by comparing the current transactional context with metadata in a repository. The process metadata include definitions of business process feature attributes of business processes within a business configuration of an organization using the business software architecture. The at least one matching business process feature is compared to scenario metadata defining a set of business process features that are part of each of a plurality of business scenarios within the business configuration. The comparing results in identification of at least one matching business scenario containing the at least one matching business process feature, and the at least one matching business process feature and the identified matching business scenario that contains the at least one matching business process feature are highlighted in a user interface.

In some variations one or more of the following features can optionally be included in any feasible combination. The detecting can optionally be performed in response to the user requesting an orientation guidance. The current transactional context can optionally include at least one of a leading business object type and instance identifier of a business object instance underlying a currently active transaction being operated on by the user, a current user interface feature being displayed to the user, a role specifier specifying of the user, and a permission level specifier specifying a permission level of the user according to the role. The highlighting can optionally further include concurrently displaying a work frame and a navigation frame. The navigation frame can optionally include a first plurality of user interface elements arranged to represent at least some of the plurality of business process features in the at least one matching business scenario. The plurality of business process features can optionally include the matching business process feature, which can optionally be highlighted with a locator user interface feature marker. The work frame can optionally include a plurality of user interface elements relating to the transaction context. A correlation agent can optionally perform at least one of the detecting, the determining, and the comparing. The at least one matching business scenario containing the at least one matching business process feature can optionally include at least two matching business scenarios, and a list that can optionally include the at least two matching business scenarios can optionally be presented according to a user-configured format.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

Implementations of the current subject matter can provide one or more advantages. For example, a user's full transactional business scenario and/or business process instance context can be determined dynamically, based on a set of characteristic properties that are part of the scenario and/or process metadata. A correlation or rule-based subscription paradigm can be applied to a business process based system, to employ an interaction of a context providing correlation agent with a correlation engine which, in turn, works based on process specific metadata defined in a process meta-model. The correlation engine and metadata, which can be stored in a repository, can allow for extensible and personalizable result ordering to give the user an optimized experience corresponding to his or her expectations.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a screenshot of a user interface illustrating a linear single business process view and associated user interface features for guided modification of aspects of a business process;

FIG. 2 shows a graphical representation of a process having aspects consistent with implementations of the current subject matter.

FIG. 3 is a process flow diagram illustrating aspects of a method having one or more features consistent with implementations of the current subject matter;

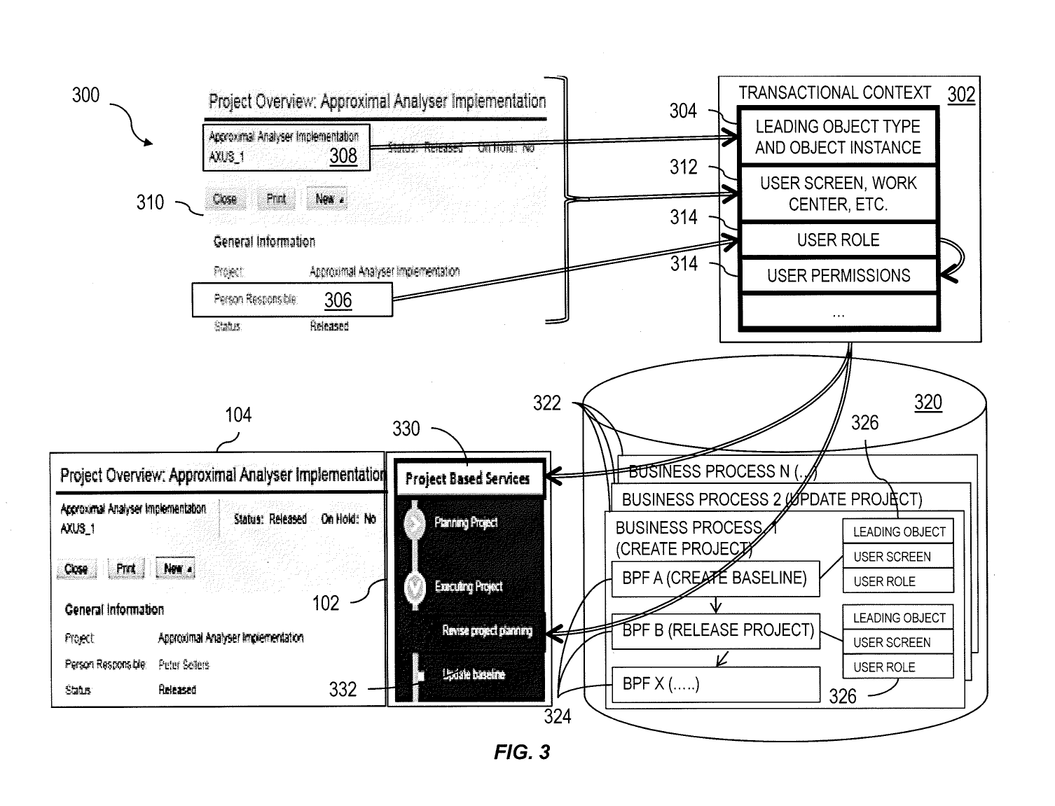

FIG. 4 is a diagram illustrating aspects of a system showing features consistent with implementations of the current subject matter;

FIG. 5 is a diagram illustrating aspects of a system showing features consistent with implementations of the current subject matter; and

FIG. 6 is a diagram illustrating a data repository showing features consistent with implementations of the current subject matter.

When practical, similar reference numbers denote similar structures, features, or elements.

### DETAILED DESCRIPTION

Business software architectures often implement a wealth of comprehensive business processes, which can be grouped together to form business scenarios in support of the business functions of the organization. A key benefit of an efficient software system can be the ability to guide a user through these scenarios and processes and to give him or her a clear indication of how a current user context (e.g. the work currently being done) fits into a larger context of an instance of a particular business scenario or business process, which user or users is or are responsible for any activities prerequisite to a currently worked on activity, and how the results of the user's current work context will impact other subsequent parts of the business. This kind of process-related information can be very useful, especially for complex, information-intensive tasks. However, smaller, self contained, or repetitive units may be more efficiently handled without knowing process context. For this reason, it can be advantageous for the business software architecture to be capable of adapting the presentation of these kinds of guidance features to a user's current work context needs.

To address these and potentially other issues with currently available solutions, methods, systems, articles of manufacture, and the like consistent with one or more implementations of the current subject matter can, among other possible advantages, provide the ability to determine a current transactional scenario or process context at any point in time and in any transactional situation of the software system, e.g. on any user screen and at any degree of completion of the current piece of work. For example, implementations of the current subject matter can dynamically determine the transactional context of a business scenario or business process instance via correlation. This capability can support visualization of the transactional process context, e.g. a “you are here” display showing a user precisely where he or she is in a specific instance of a business scenario or business process at any given time based on the current use context displayed to the user via a user interface.

A scenario landscape for an organization can refer to a set including all or some of the business scenarios and/or business processes characterizing an organization's operations. In general a business scenario can includes one or more business processes, process steps, or other business process features. Business process features can include, but are not limited to, one or more of business processes, process steps, sub-processes, tasks, activities, and the like. The business scenarios and business processes can be managed, and tasks relating to the completion of one or more steps of the business processes can be supported by, one or more feature modules of a business software architecture, such as for example an enterprise resource planning (ERP) system. The terms “instance of a business process,” “instance of a business scenario,” and similar descriptive terminology is intended to refer to a specific execution of a business process or a business scenario, respectively. For example, for a business scenario relating to sale of a product, each order taken and filled for that product can be considered as an instance of the business scenario. A business configuration can be a set of business scenarios including sets of business processes or business process features supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

The characteristic properties of a user's working environment can be important for deriving a current business scenario or business process context. Characteristic properties can include, but are not limited to, a currently active user interface screen, a currently active user interface element or set of elements, a currently active work center (e.g. a user interface “unit” built around a set of tasks or activities), a leading business object the user is currently interacting with, the user's role assignments, and the like. A list of characteristic properties specific to the software system at hand can be defined and made part of a business scenario or business process meta-model, so that characteristic properties (e.g. property instances) can be stored as part of each business scenario or business process model attached to the entities, which they identify in a characteristic way.

Identified entities can be the business process features in a business scenario or business process, which can be specific enough to allow such assignments because the identified entities generally refer to dedicated activities (e.g. “assign user X's travel expenses to project ABC”) and are assigned to individual users or groups of users. When a user enacts a task, activity, etc., or otherwise interacts with one or more user interface features in the system and issues a request to have the surrounding transactional process context displayed, a correlation agent module can automatically collect the characteristic properties in the user's current working environment. The characteristic properties can optionally include one or more of a current screen or user interface feature(s), a leading and/or selected business object, a current user role, or the like. The correlation agent module can transfer the collected characteristic properties to a correlation engine, which can search a process metadata repository to identify all business process features in an organization's business configuration that match the set of collected characteristic properties.

By a process consistent with implementations of the current subject matter, the correlation engine can generate a list of locations, for example business process features within a business scenario or business process that match the user's current use context. A comprehensive business software architecture can include a wealth of related scenario or process model variants, so it is possible that more than one business process feature can match the user's current use context. Accordingly, implementations of the current subject matter can include an annotation of the hit probability for each correlation in the business scenario or business process model. In some variations, a user can be allowed to prioritize this hit list so that the system can present an expected, preferred choice to the user based on additional criteria specified by the user. In this manner, a preferred outcome can be decided. Other possible matches can optionally be indicated by a visual or other indication in the user interface and can be displayed upon further request by the user.

Within a business scenario or business process instance representation in a user interface, a “YOU ARE HERE” indicator or a comparable locator icon or other locator user interface feature marker can be provided to show the user where exactly in the surrounding business scenario or business process instance he or she is currently operating. Based on this current position, the interpretation of the business scenario or business process instance can make significantly more sense to the user, as a potentially large number business process features can be more readily parsed into two logical groups: business process features occurring prior to the current position in a business scenario or business process (e.g. in the past for the selected instance of the business scenario or business process) and business process features occurring subsequent to the current activity position in the business scenario or business process (e.g. in the future for the selected instance of the business scenario or business process). This kind of visual orientation with regards to a current position within a business scenario instance or business process instance can allow the user to intuitively grasp where he or she is in the business scenario or business process and to decide on what to do next or how to interpret results from previous business process features in the business scenario instance or business process instance.

If more than one location (business process feature) of the same business scenario or business process instance is found to correlate with the current user use context, then all possible hits can be displayed at once in the same process instance display. The locator user interface feature can then instead be presented as an options user interface feature (e.g. a “YOU CAN DO ONE OF THE FOLLOWING FROM HERE” indicator). Each of the presented activities in a list can relate to the user's current use context and together can show the set of possible actions that can be carried out if the current status of the business scenario or business process instance permits. If the correlation engine returns hits that point to different business scenarios or business processes, then the user can be offered the choice to navigate to these other business scenario or business process contexts, which can then show different aspects of the user's current use context, separated by business scenario or business process. For example, the same business object can be part of a customer invoicing business scenario and, at the same time, of a delivery business scenario. Switching between these two business scenario contexts can show the same object in either of these two roles: as part of the invoicing business scenario and, alternatively, as part of the pending delivery business scenario.

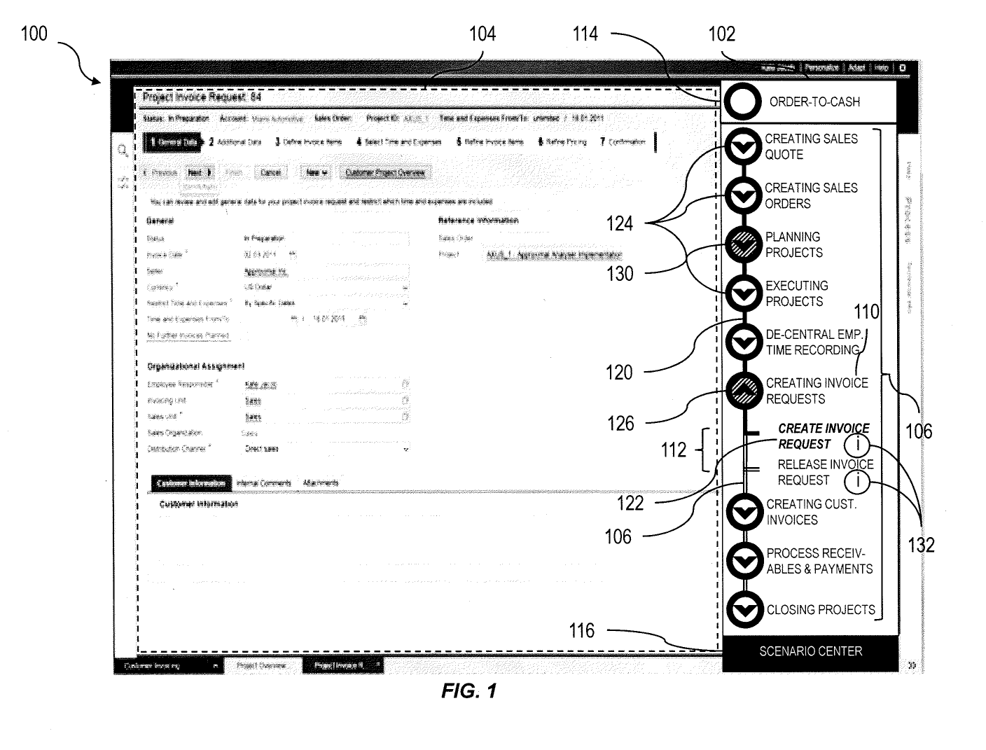

FIG. 1 illustrates an example of a linear single scenario view 100, which shows a single business scenario as a linear sequence of business process features, which can be business processes, process steps, sub-processes, tasks, activities, etc. represented by a set of first user interface features. The structure of the business scenario is condensed into a linear view, even though the actual flow of business process features necessary to complete an instance of the business scenario often involves explicit parallelism, decisions, loops, event driven changes in control flow, exceptions, and the like. Consistent with the scope of the current subject matter, any viable approach can be used to shape a business scenario into such a linear view.

As shown in FIG. 1, a scenario navigation pane 102 and a work pane 104 are concurrently displayed. A plurality of first user interface elements 106 are displayed in the scenario navigation pane 102 and arranged in a linear progression to represent the linear sequence of business process features in the scenario model of the currently actively business scenario. A first user interface element 110 corresponding to a business process 106 having additional process steps can be expanded as shown in FIG. 1 to display additional user interface elements 112 corresponding to the process steps. Also as shown in FIG. 1, the currently displayed business scenario can be identified by one or more scenario identifier user elements 114. A scenario browser user interface element 116 can link to an upper level scenario landscape overview map showing a higher level view of intersections between business processes and providing links to navigate to the other processes in the scenario landscape.

The first user interface elements 106 can optionally be displayed in a manner similar to a transit route map with each business process feature within the displayed scenario being represented like a stop on the route. In this manner, a familiar visual format can rapidly convey additional information about a current context within a specific instance of the business scenario as well as status information about the various business process features along the “route” to completion of the business scenario instance. For example, a route line 120 connecting the “stops” can be presented with a first visual effect (e.g. color, brightness, shade, dots or dashes, etc.) up to the “stop” representing the business process feature that is currently “active” with related functionality being provided in the work pane 104. The currently active business process feature can be further indicated using textual or visual cues, such as for example color, shading, font, a highlighting box, etc. As a non-limiting example, the name of the business process feature displayed in conjunction with the user interface element 122 corresponding to the currently active business process feature in FIG. 1 is formatted in a bold and italicized font. A different second visual effect can be used for the route line 120 leading to the “stops” past the currently active business process feature. The icons 124 used to represent the “stops” in the scenario navigation pane can also include visual cues to inform a user about a status of one or more of the business process features, other business process feature that are included within the currently displayed business process feature user interface elements and that can be revealed by a user action to expand the route map, or the like.

Also in the example shown in FIG. 1, the expanded business process feature 110 includes process steps within a business process that are illustrated by first user elements 112 incorporated directly into the route map without branching to maintain the linear progression of the scenario model. The first user interface element 126 representing the “stop” corresponding to this business process feature 110 can include visual presentation features to indicate that it is currently expanded as shown in FIG. 1. Additional first user interface elements 132 (e.g. the “i” icons shown in FIG. 1) can provide a link to a customization screen that can be displayed in the work pane 104 to allow a user to modify a link between a corresponding business process feature and second user interface elements to be displayed in the work pane 104 during execution of an instance of the business scenario. The additional first user interface elements 132 (e.g. the “i” icons shown in FIG. 1) or other similar features can additionally or alternatively provide a link to one or more additional screens displaying additional details regarding an associated business process feature.

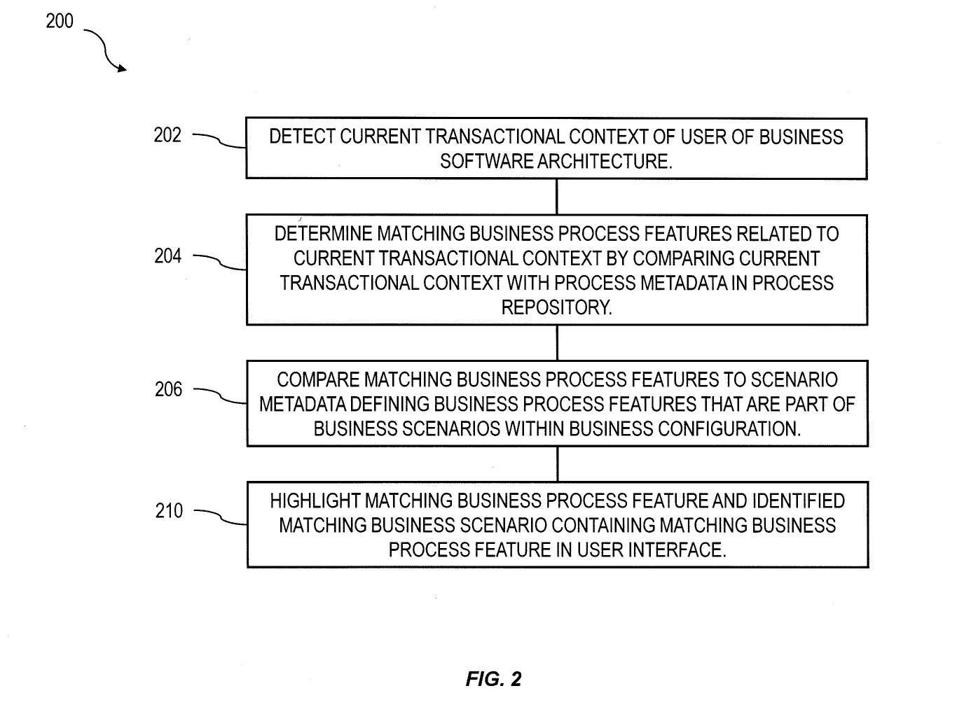

FIG. 2, which shows a process flow diagram 300, and FIG. 2, which shows a graphical depiction of data flows and actions, together illustrate features consistent with implementations of the current subject matter. At 202, a current transactional context 302 of a user of a business software architecture is detected. The detecting can optionally be done by a correlation agent or other similar software module or functionality. The transactional context 302 can optionally include one or more of a leading object type and object instance identifier 304 identifying a user name 306 and a currently active leading business object 308 underlying a currently presented user interface screen or set of user interface features 310, a user interface screen/element or work center identifier 312 identifying the currently presented user interface screen or set of user interface features 310, a user role specifier 314 specifying role or roles within the organization that apply to the user 306, a user permissions specifier 316 specifying permissions held by the user 306, which can be linked to or otherwise based upon the role or roles of the user 306.

At 204, the transactional context 302 is compared, optionally by a correlation engine or other similar software module or functionality, with metadata in at least one process repository 320 to determine one or more matching business process features (e.g. business process, business process steps, etc.) that are related to the transactional context 302. The process repository 320 can optionally include a set of process meta-models 322 contains the process metadata for each business process available within the organization's business configuration. The process meta-models can each include definitions of attributes of the associated business process, e.g one or more process steps or other business process features 324, and each business process feature can include an associated set of metadata 326, for example specifying one or more of a leading business object, a user screen, a user role, or the like that correspond to that business process feature.

At 206, the one or more matching business process features are compared to scenario metadata in scenario meta-models defining business process features that are part of each of a plurality of business scenarios within the organization's business configuration. The scenario meta-models can optionally be stored either in the at least one process repository 320 or in one or more scenario repositories, etc. The comparing can result in identification of one or more matching scenarios that contain the matching business process features. Using this matching scenario information and/or the matching business process feature information, the user interface can be augmented with a navigation pane 102 showing a linear representation of the matching business scenario, which can be identified by a scenario label user interface element 330. A matching business process feature can be highlighted at 210, for example with a locator user interface feature marker 332 (e.g. textual formatting, color, boxing, shading, or any available means of highlighting) in the navigation pane 102. As noted above in the discussion of FIG. 1, the navigation pane 102 can be shown concurrently with a work pane showing the original user interface elements that defined the transactional context.

In the event that multiple matching business features are identified, a menu, list, or the like can be first displayed to allow selection of the intended matching business process feature. Similarly, if multiple scenarios are determined to match the current transaction context, a menu, list, etc. of possibly matching business scenarios can be displayed so that the user can selected a desired business scenario to be displayed in the navigation pane 102. The matching scenario information and/or the matching business process feature information can optionally be persisted, for example by storing such information to a database or to a repository.

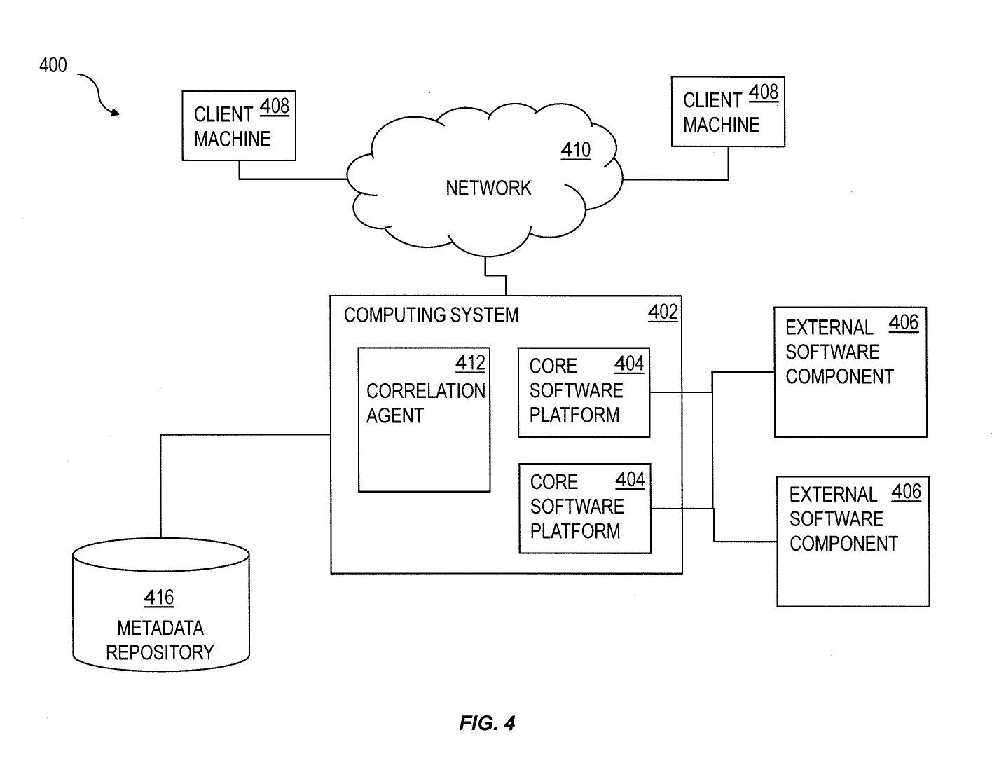

The core software platform of an ERP or other business software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 4 shows a diagram of a system consistent with such an implementation. A computing system 402 can include one or more core software platform modules 404 providing one or more features of the ERP system. The computing system can also aggregate or otherwise provide a gateway via which users can access functionality provided by one or more external software components 406, which can optionally be provided by service providers external to the one or more core software platform modules 404. Client machines 408 can access the computing system, either via a direct connection, a local terminal, or over a network 410 (e.g. a local area network, a wide area network, a wireless network, the Internet, or the like). A correlation agent 412 can be hosted on the computing system 402 or alternatively, on an external system accessible over a network connection. The correlation agent 412 can optionally include one or more discrete software and/or hardware modules that perform operations such as those described herein.

The correlation agent 412 can access one or more metadata repositories and/or other data repositories 416 (e.g. process repositories, scenarios repositories, transactional data repositories, etc.) that can store definitions of business scenarios, business processes, and one or more business configurations as well as data, metadata, master data, etc. relating to definitions of the business scenarios, business processes, and one or more business configurations, and/or concrete instances of the data objects (e.g. business objects) that are relevant to a specific instance of the business scenario or a business process. In some examples, the definition can optionally be stored as a business object. In some implementations, the business object can include a template definition of a standard business process. The template definition that can optionally be modified via one or more extensions that are stored in the one or more metadata repositories 416.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

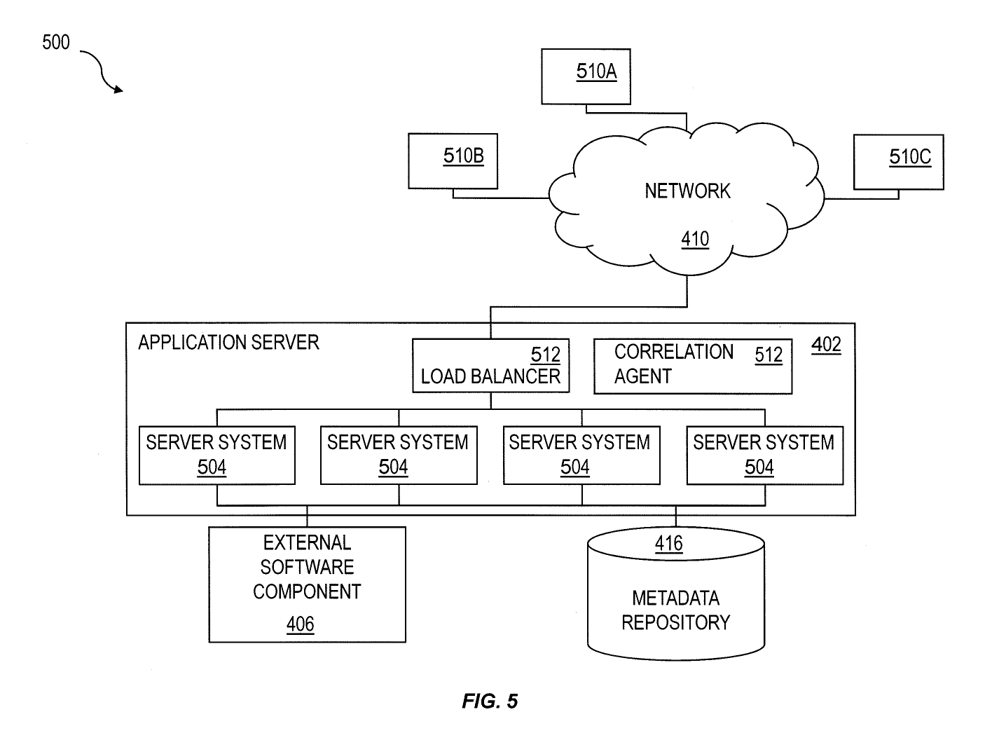

FIG. 5 shows a block diagram of a multi-tenant implementation of a software delivery architecture 500 that includes an application server 502, which can in some implementations include multiple server systems 504 that are accessible over a network 410 from client machines operated by users at each of multiple organizations 510A-510C (referred to herein as “tenants” of a multi-tenant system) supported by a single software delivery architecture 500. For a system in which the application server 502 includes multiple server systems 504, the application server can include a load balancer 512 to distribute requests and actions from users at the one or more organizations 510A-510C to the one or more server systems 504. Instances of the core software platform 404 (not shown in FIG. 5) can be executed in a distributed manner across the server systems 504. A user can access the software delivery architecture across the network using a thin client, such as for example a web browser or the like, or other portal software running on a client machine. The application server 502 can access data and data objects stored in one or more data repositories 416. The application server 502 can also serve as a middleware component via which access is provided to one or more external software components 406 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 502 that includes multiple server systems 504 that handle processing loads distributed by a load balancer 512. Potential benefits from such an arrangement can include, but are not limited to, high and reliably continuous application server availability and minimization of unplanned downtime, phased updating of the multiple server systems 504 to permit continuous availability (one server system 504 can be taken offline while the other systems continue to provide services via the load balancer 512), scalability via addition or removal of a server system 504 that is accessed via the load balancer 512, and de-coupled lifecycle processes (such as for example system maintenance, software upgrades, etc.) that enable updating of the core software independently of tenant-specific customizations implemented by individual tenants.

As in the example illustrated in FIG. 4, the metadata repository 416 can store a business object that represents a template definition of a standard business process. Each individual tenant 510A-510C can customize that standard template according to the individual business process features specific to business of the organization to which that tenant is assigned. Customizations can be stored as extensions in the metadata repository.

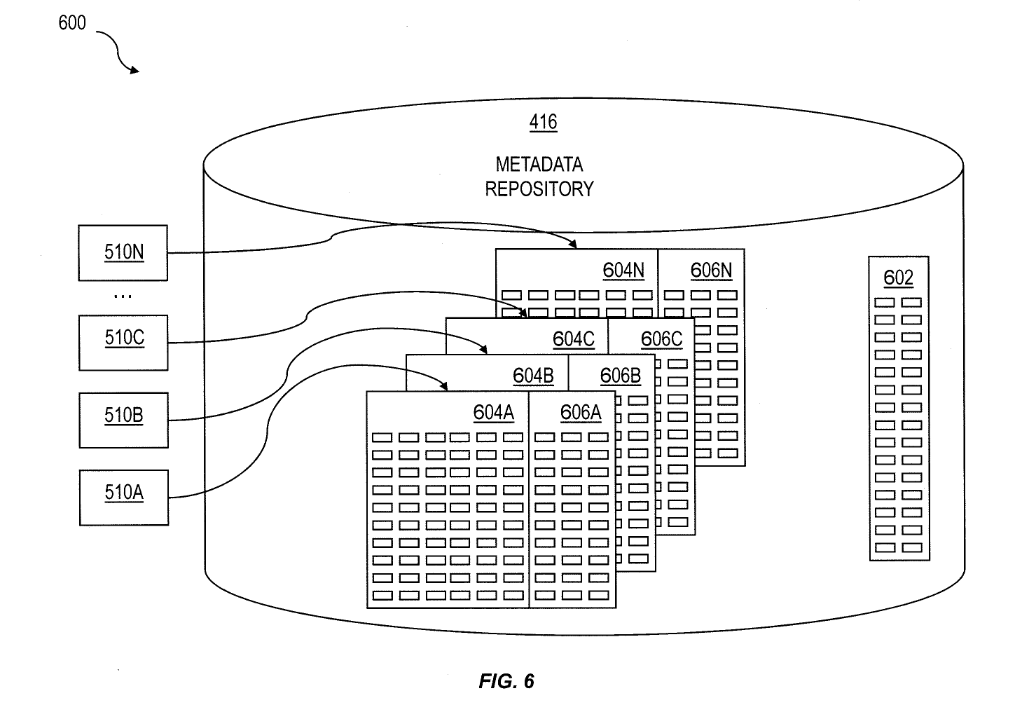

To provide for customization of the business process for each of multiple organizations supported by a single software delivery architecture 500, the data and data objects stored in the metadata repository 416 and/or other data repositories that are accessed by the application server 502 can include three types of content as shown in FIG. 6: core software platform content 602 (e.g. a standard definition of a business process), system content 604, and tenant content 606. Core software platform content 602 includes content that represents core functionality and is not modifiable by a tenant. System content 604 can in some examples be created by the runtime of the core software platform and can include core data objects that store concrete data associated with specific instances of a given business process and that are modifiable with data provided by each tenant. The data retained in these data objects are tenant-specific: for example, each tenant 510A-510N can store information about its own inventory, sales order, etc. Tenant content 606A-606N includes data objects or extensions to other data objects that are customized for one specific tenant 510A-510N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 606 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 602 and system content 604 and tenant content 606 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
detecting a current transactional context of a user of a business software architecture;
determining at least one matching business process feature related to the current transactional context by comparing the current transactional context with process metadata in a process repository, the process metadata comprising definitions of business process feature attributes of business processes within a business configuration of an organization using the business software architecture;
comparing the at least one matching business process feature to scenario metadata defining a set of business process features that are part of each of a plurality of business scenarios within the business configuration, the comparing resulting in identification of at least one matching business scenario containing the at least one matching business process feature;
highlighting, in a user interface displayed on a display device, the at least one matching business process feature and the identified matching business scenario that contains the at least one matching business process feature.

2. A computer program product as in claim 1, wherein the operations further comprise performing the detecting in response to the user requesting an orientation guidance.

3. A computer program product as in claim 1, wherein the current transactional context comprises at least one of a leading business object type and instance identifier of a business object instance underlying a currently active transaction being operated on by the user, a current user interface feature being displayed to the user, a role specifier specifying of the user, and a permission level specifier specifying a permission level of the user according to the role.

4. A computer program product as in claim 1, wherein the highlighting further comprises concurrently displaying a work frame and a process navigation frame, the process navigation frame comprising a first plurality of user interface elements arranged to represent at least some of the plurality of business process features in the at least one matching business scenario, the plurality of business process features comprising the matching business process feature which is highlighted with a locator user interface feature marker, the work frame comprising a plurality of user interface elements relating to the transaction context.

5. A computer program product as in claim 1, wherein a correlation agent performs at least one of the detecting, the determining, and the comparing.

6. A computer program product as in claim 1, wherein the at least one matching business scenario containing the at least one matching business process feature comprises at least two matching business scenarios, and the operations further comprise presenting a list comprising the at least two matching business scenarios according to a user-configured format.

7. A system comprising:
at least one programmable processor; and
a machine-readable medium storing instructions that, when executed by the at least one processor, cause the at least one programmable processor to perform operations comprising:
detecting a current transactional context of a user of a business software architecture;
determining at least one matching business process feature related to the current transactional context by comparing the current transactional context with process metadata in a process repository, the process metadata comprising definitions of business process feature attributes of business processes within a business configuration of an organization using the business software architecture;
comparing the at least one matching business process feature to scenario metadata defining a set of business process features that are part of each of a plurality of business scenarios within the business configuration, the comparing resulting in identification of at least one matching business scenario containing the at least one matching business process feature; and
highlighting, in a user interface displayed on a display device, the at least one matching business process feature and the identified matching business scenario that contains the at least one matching business process feature.

8. A system as in claim 7, wherein the operations further comprise performing the detecting in response to the user requesting an orientation guidance.

9. A system as in claim 7, wherein the current transactional context comprises at least one of a leading business object type and instance identifier of a business object instance underlying a currently active transaction being operated on by the user, a current user interface feature being displayed to the user, a role specifier specifying of the user, and a permission level specifier specifying a permission level of the user according to the role.

10. A system as in claim 7, wherein the highlighting further comprises concurrently displaying a work frame and a process navigation frame, the process navigation frame comprising a first plurality of user interface elements arranged to represent at least some of the plurality of business process features in the at least one matching business scenario, the plurality of business process features comprising the matching business process feature which is highlighted with a locator user interface feature marker, the work frame comprising a plurality of user interface elements relating to the transaction context.

11. A system as in claim 7, wherein a correlation agent performs at least one of the detecting, the determining, and the comparing.

12. A system as in claim 7, wherein the at least one matching business scenario containing the at least one matching business process feature comprises at least two matching business scenarios, and the operations further comprise presenting a list comprising the at least two matching business scenarios according to a user-configured format.

13. A computer-implemented method comprising:
detecting a current transactional context of a user of a business software architecture;
determining at least one matching business process feature related to the current transactional context by comparing the current transactional context with process metadata in a process repository, the process metadata comprising definitions of business process feature attributes of business processes within a business configuration of an organization using the business software architecture;
comparing the at least one matching business process feature to scenario metadata defining a set of business process features that are part of each of a plurality of business scenarios within the business configuration, the comparing resulting in identification of at least one matching business scenario containing the at least one matching business process feature; and
highlighting, in a user interface displayed on a display device, the at least one matching business process feature and the identified matching business scenario that contains the at least one matching business process feature.

14. A computer-implemented method as in claim 13, further comprising performing the detecting in response to the user requesting an orientation guidance.

15. A computer-implemented method as in claim 13, wherein the current transactional context comprises at least one of a leading business object type and instance identifier of a business object instance underlying a currently active transaction being operated on by the user, a current user interface feature being displayed to the user, a role specifier specifying of the user, and a permission level specifier specifying a permission level of the user according to the role.

16. A computer-implemented method as in claim 13, wherein the highlighting further comprises concurrently displaying a work frame and a process navigation frame, the process navigation frame comprising a first plurality of user interface elements arranged to represent at least some of the plurality of business process features in the at least one matching business scenario, the plurality of business process features comprising the matching business process feature which is highlighted with a locator user interface feature marker, the work frame comprising a plurality of user interface elements relating to the transaction context.

17. A computer-implemented method as in claim 13, wherein a correlation agent performs at least one of the detecting, the determining, and the comparing.

18. A computer-implemented method as in claim 13, wherein the at least one matching business scenario containing the at least one matching business process feature comprises at least two matching business scenarios, and the method further comprises presenting a list comprising the at least two matching business scenarios according to a user-configured format.

19. A computer-implemented method as in claim 13, wherein at least one of the detecting, the determining, the comparing, and the highlighting is performed by at least one programmable processor.
